(19) United States
(12) Patent Application Publication
(10) Pub. No.: US 2018/0140999 A1
(43) Pub. Date: May 24, 2018

(54) DECOMPOSITION OF AMMONIUM HALIDES FOR MERCURY EMISSIONS REDUCTION

(71) Applicant: General Electric Technology GmbH, Baden (CH)

(72) Inventor: Per-Erik Albert APPELO, Knoxville, TN (US)

(21) Appl. No.: 15/355,614

(22) Filed: Nov. 18, 2016

(51) Int. Cl. B01D 53/78; B01D 53/64; B01D 53/34

(52) U.S. Cl. CPC B01D 53/78; B01D 53/64; B01D 2257/602; B01D 2251/108; B01D 53/346

(57) ABSTRACT

Apparatus and methods for coal combustion and for flue gas mercury emissions reduction following the combustion of coal use ammonium halides. Ammonium halides are supplied to a perforated housing within a duct for decomposition and release of NH₃ and HBr or HCl into the flue gas for oxidation of elemental mercury present in the flue gas. The oxidized mercury is then separated from the flue gas using a particulate collection system and/or a wet flue gas desulfurization system for flue gas mercury emissions reduction.

### FIELD OF THE DISCLOSURE

In general, this disclosure relates to apparatus and methods for coal combustion and for mercury emissions reduction following the combustion of coal. More specifically, this disclosure relates to apparatus and methods for the reduction of mercury emissions from coal combustion using ammonium halides.

### BACKGROUND OF THE DISCLOSURE

Emissions from coal combustion often contain oxides of nitrogen (NOₓ) and volatile metals such as mercury (Hg). A long felt need exists to reduce Hg and NOx in gaseous emissions from coal fueled boilers and other industrial coal combustion systems.

As mercury volatizes during coal combustion, the mercury enters the flue gas generated by combustion. Some of the volatized mercury is captured in coal fly ash and removed via a particulate collection system. Volatized mercury not captured in the particulate collection system, or by some other control system, passes into the atmosphere with the flue gas generated in the boiler or combustion system. It is desirable to capture flue gas mercury to reduce or prevent discharge to the atmosphere.

Mercury volatizes as elemental mercury)(Hg⁰) during coal combustion. Oxidized mercury (Hg²⁺) is more easily collected by emission control systems than is elemental mercury. Oxidation of mercury is a known technique to capture mercury and to remove the captured mercury from flue gas. As flue gas cools, mercury is partially oxidized by chlorine which is present in coal and released during coal combustion. Most oxidized mercury (Hg²⁺) in flue gas is present as mercury chloride (HgCl₂). Oxidation of mercury occurs in combustion gas-phase reactions and on the surface of fly ash. Mercury oxidation on the surface of fly ash is believed to be a predominant channel of mercury oxidation.

Oxidized mercury (HgCl₂ or Hg²⁺) is water soluble and is relatively easily adsorbed on high carbon fly ash or activated carbon. The oxidized mercury captured by fly ash may be collected with the ash and removed via a particulate collection system. Oxidized mercury is also relatively easily removed by wet scrubbers used to control sulfur dioxide (SO₂) emissions. Mercury control is generally most effective when the mercury in the flue gas is mostly oxidized.

Controlling mercury emissions is complicated because mercury is present in flue gas in several different forms, such as elemental mercury)(Hg⁰) and oxidized mercury (Hg²⁺). Mercury changes forms throughout the combustion process. To effectively control mercury emissions, a control system must be specific to the form(s) or speciation(s) of the mercury present in the flue gas at the location of the control system in the flue gas stream.

### SUMMARY OF THE DISCLOSURE

A plant comprising equipment or apparatus for the reduction of mercury emissions from coal combustion using ammonium halides is disclosed herein. As such, the subject plant includes a combustion unit that combusts a fuel to produce steam. The produced steam may be supplied to a steam turbine for use in generating electricity, or supplied elsewhere for other uses such as for example district heating, process heating, or the like. The fuel supplied to the combustion unit can be coal, or another mercury-containing fuel. In the combustion of such a fuel in the presence of oxygen within the combustion unit, in addition to producing steam, a flue gas is produced. Optionally, the produced flue gas flows from the combustion unit to a fluidly connected nitrogen oxide reducing system via a duct.

In a fixed arrangement within the duct fluidly connecting the combustion unit to the nitrogen oxide reducing system, is ammonium halide decomposition apparatus or equipment. The ammonium halide decomposition apparatus or equipment comprises a perforated housing, a feeder with a motor operative to mechanically feed solid NH₄Br or solid NH₄Cl from a solid NH₄Br or solid NH₄Cl supply to a heated interior area defined by the perforated housing, one or more sensors for measuring plant operating parameters to obtain parameter measurements for electronic transmission of the parameter measurements to a control device for receipt of the parameter measurements by the control device, and the control device electronically operative via electronic signal to adjust operation of the motor to affect feed rate of solid NH₄Br or solid NH₄Cl from the solid NH₄Br or solid NH₄Cl supply to the interior of the perforated housing based on the received parameter measurements. The solid NH₄Br or solid NH₄Cl supplied to the perforated housing decomposes within the perforated housing thereby releasing NH₃ and HBr or HCl to the flue gas flowing through the duct for oxidation of elemental mercury)(Hg⁰) present in the flue gas, upstream of the nitrogen oxide reducing system.

Alternatively, in a fixed arrangement within the duct fluidly connecting the combustion unit to the nitrogen oxide reducing system, is ammonium halide decomposition apparatus or equipment. The ammonium halide decomposition apparatus or equipment comprises a perforated housing, a feeder tube with a motor or pump operative to mechanically feed a solution of NH₄Br or NH₄Cl dissolved in water from a NH₄Br or NH₄Cl and water solution supply to an interior reservoir defined by solid walls a part of or constructed within the perforated housing, one or more sensors for measuring plant operating parameters to obtain parameter measurements for electronic transmission of the parameter measurements to a control device for receipt of the parameter measurements by the control device, and the control device electronically operative via electronic signal to adjust operation of the motor or pump to affect feed rate of the NH₄Br or NH₄Cl and water solution from the NH₄Br or NH₄Cl and water solution supply to the interior reservoir of the perforated housing based on the received parameter measurements. The water from the NH₄Br or NH₄Cl and water solution supplied to the perforated housing evaporates precipitating ammonium halide salts on surfaces of the perforated housing. These precipitated ammonium halide salts decompose releasing NH₃ and HBr or HCl into the flue gas flowing through the duct for oxidation of elemental mercury)(Hg⁰) present in the flue gas, upstream of the nitrogen oxide reducing system.

The nitrogen oxide reducing system may be a selective catalytic reduction (SCR) system, a selective non-catalytic reduction (SNCR) system or another type of system configured to remove nitrogen oxides, e.g., NO₂, NO₃, NOₓ, from the flue gas. After removal of nitrogen oxides from the flue gas in the nitrogen oxide reducing system, the flue gas flows via a duct into an air preheater.

If the air preheater is operated with a recirculation of heat transfer fluid, heat energy from the relatively hot flue gas is transferred to a heat transfer fluid thereby cooling the relatively hot flue gas to obtain a relatively cool flue gas, while heating a relatively cool heat transfer fluid to obtain a relatively hot heat transfer fluid. The relatively hot heat transfer fluid flows from the air preheater to the combustion unit for beneficial use of the transferred heat energy in the combustion unit for fuel combustion and steam production. Following beneficial so use of the transferred heat energy in the combustion unit, the resulting relatively cool heat transfer fluid then circulates from the combustion unit back to the air preheater for reheating. The heat transfer fluid may be water, an oil, or a similar such heat retaining fluid. If the air preheater is not operated with a recirculation of heat transfer fluid, such as in the case of the air preheater being a regenerative rotating type heat exchanger, the heat transfer fluid, such as ambient air, an oxygen-containing gas O, such as O₂ gas or another gas containing O₂ gas supplied from an oxygen-containing gas supply, or the like, flows into the air preheater. Heat energy from the relatively hot flue gas is transferred to the heat transfer fluid thereby cooling the relatively hot flue gas to obtain a relatively cool flue gas, while heating the relatively cool heat transfer fluid to obtain a relatively hot heat transfer fluid. The relatively hot heat transfer fluid flows from the air preheater to the combustion unit for beneficial use of the transferred heat energy in the combustion unit for fuel combustion and steam production. Following beneficial use of the transferred heat energy in the combustion unit, the heat transfer fluid flows out of the combustion unit with flue gas generated within the combustion unit. After flowing through the air preheater, the now relatively cool flue gas flows to a fluidly connected particulate collection system via a duct.

The particulate collection system is arranged for flue gas flow therethrough for separation of solid material, such as combustion fly ash, dust, and the like, from the flue gas. Hence, oxidized mercury (Hg²⁺) adsorbed or precipitated onto combustion fly ash is separated as solid material from the flue gas. For such purpose, the particulate collection system is a filter system or an electrostatic precipitator system. After the removal of solid material from the flue gas in the particulate collection system, the flue gas flows via a duct into a wet flue gas desulfurization (WFGD) system.

Within the wet flue gas desulfurization (WFGD) system, an alkaline reagent such as lime, hydrated lime, sodium carbonate, trona, and/or alkaline fly ash, and a liquid such as water and/or recycled waste water are supplied as a reagent slurry for contact with the flue gas flowing therethrough. Such intermixing contact between the reagent slurry and the flue gas results in a reaction between acid gas such as hydrogen chloride (HCl), hydrogen fluoride (HF), sulfur dioxide (SO₂), sulfur trioxide (SO₃), and sulfuric acid (H₂SO₄), present in the flue gas and the reagent slurry. This reaction between the acid gas and the reagent slurry produces a solid reaction product such as calcium sulfite (CaSO₃), calcium sulfate (CaSO₄), calcium chloride (CaCl₂), and/or calcium fluoride (CaF₂), thereby removing acid gas from the flue gas. By so removing acid gas from the flue gas, flue gas acid gas emissions are reduced. Likewise, any remaining oxidized mercury (Hg²⁺) in the flue gas is removed from the flue gas by the reagent slurry, thereby reducing flue gas mercury emissions. After reducing acid gas and mercury in the flue gas, the so produced cleaned flue gas CG flows via a duct from the WFGD system to a stack for release to the environment from the stack. Reagent slurry used in the WFGD system may be recirculated within the WFGD system for repeated use, with solid reaction product continuously or periodically removed from the WFGD system for use elsewhere within the plant, or for use in the production of gypsum wall board or the like. Waste water from WFGD system may be continuously or periodically removed for supply to plant equipment useful for eliminating waste water discharge or useful for other waste water treatment.

A method of using equipment or apparatus for the reduction of mercury emissions from coal combustion using ammonium halides comprises fixedly arranging within a duct upstream of a nitrogen oxide reducing system a perforated housing, measuring plant operating parameters using one or more sensors to obtain parameter measurements electronically transmitted to a control device for receipt of the parameter measurements by the control device, adjusting through control device electronic signal a supply rate of solid NH₄Br or solid NH₄Cl to the perforated housing based on parameter measurements received by the control device, supplying via a feeder the solid NH₄Br or solid NH₄Cl to a heated interior area of the perforated housing at the supply rate, decomposing the solid NH₄Br or solid NH₄Cl in the perforated housing for release of NH₃ and HBr and/or HCl from the perforated housing into flue gas flowing through the duct for oxidation of elemental mercury)(Hg⁰) present in the flue gas to produce oxidized mercury (Hg²⁺) prior to flue gas flow into the nitrogen oxide reducing system, and removing precipitated oxidized mercury (Hg²⁺) in a particulate collection system to reduce mercury emissions.

Another method of using equipment or apparatus for the reduction of mercury emissions from coal combustion using ammonium halides comprises fixedly arranging within a duct upstream of a nitrogen oxide reducing system a perforated housing, measuring plant operating parameters using one or more sensors to obtain parameter measurements electronically transmitted to a control device for receipt of the parameter measurements by the control device, adjusting through control device electronic signal a supply rate of a NH₄Br or NH₄Cl and water solution to an interior reservoir of the perforated housing based on the received parameter measurements, supplying the NH₄Br or NH₄Cl and water solution to the interior reservoir within the perforated housing at the supply rate, evaporating water from the NH₄Br or NH₄Cl and water solution for ammonium halide salt precipitation within the perforated housing, decomposing the precipitated ammonium halide salt for release of NH₃ and HBr and/or HCl from the perforated housing into flue gas flowing through the duct for oxidation of elemental mercury)(Hg⁰) present in the flue gas to produce oxidized mercury (Hg²⁺) prior to flue gas flow into the nitrogen oxide reducing system, and removing precipitated oxidized mercury (Hg²⁺) in a particulate collection system to reduce mercury emissions.

In summary, disclosed herein is an apparatus for flue gas mercury emissions reduction that comprises a perforated housing arranged within a duct for a flow of a mercury-containing flue gas through the duct, an ammonium halide supply supplying ammonium halide to a heated interior area of the perforated housing, heated to a temperature of ammonium halide decomposition, one or more sensors for measuring operating parameters within the duct and/or perforated housing to obtain parameter measurements electronically transmitted to a control device, and the control device based on received parameter measurements adjusting through electronic signal a rate of supply of the ammonium halide from the ammonium halide supply to the heated interior area of the perforated housing, wherein within the heated interior area of the perforated housing the ammonium halide decomposes releasing NH₃ and HBr or HCl for oxidation of elemental mercury to obtain oxidized mercury for separation from the mercury-containing flue gas. The apparatus further comprises an ammonia delivery system supplying a spray of ammonia within the duct and into the flow of mercury-containing flue gas through the duct. The heated interior area of the perforated housing is heated to a temperature of about 300° C. to about 490° C., or about 400° C. The ammonium halide supply supplies a solid ammonium halide or an ammonium halide solution to the heated interior area of the perforated housing. As such, the ammonium halide supply may supply an about 20 percent to about 70 percent, or an about 40 percent ammonium halide solution to the heated interior area of the perforated housing. The apparatus duct may comprise a vertical portion, and the perforated housing may be manufactured from a cut and expanded metal sheet. The apparatus may further comprise a particulate collection system and/or wet flue gas desulfurization system for separating the oxidized mercury from the flue gas.

In summary, disclosed herein is a method for flue gas mercury emissions reduction that comprises arranging a perforated housing within a duct for a flow of a mercury-containing flue gas through the duct, supplying an ammonium halide from an ammonium halide supply to a heated interior area of the perforated housing heated to a temperature of ammonium halide decomposition, measuring with one or more sensors operating parameters within the duct and/or perforated housing to obtain parameter measurements electronically transmitted to a control device, adjusting through electronic signal from the control device a rate of supply of the ammonium halide from the ammonium halide supply to the heated interior area of the perforated housing based on control device received parameter measurements, and releasing NH₃ and HBr or HCl through decomposition of the ammonium halide for oxidation of elemental mercury present in the mercury-containing flue gas to obtain oxidized mercury for separation from the mercury-containing flue gas. The method further comprises supplying a spray of ammonia within the duct and into the flow of mercury-containing flue gas through the duct. The heated interior area of the perforated housing is heated to a temperature of about 300° C. to about 490° C., or about 400° C. The ammonium halide supplied to the perforated housing may be a solid ammonium halide or an ammonium halide solution. As such, the ammonium halide supplied to the perforated housing may be an about 20 percent to about 70 percent, or about 40 percent ammonium halide solution. Further, the duct may comprise a vertical portion. The perforated housing according to the method may be manufactured from a cut and expanded metal sheet. Also, the method may further comprise separating the oxidized mercury from the flue gas using a particulate collection system and/or a wet flue gas desulfurization system.

Additional features of the subject equipment or apparatus useful for reducing mercury emissions from coal combustion using ammonium halides, and the subject methods of using the equipment or apparatus for reducing mercury emissions from coal combustion using ammonium halides, will become apparent from the following description in which the subject equipment or apparatus and methods of using the same are set forth in detail in conjunction with the accompanying drawings.

### BRIEF DESCRIPTION OF THE DRAWINGS

The subject equipment or apparatus for reducing flue gas mercury emissions from fuel combustion using ammonium halides, and the subject methods for reducing flue gas mercury emissions from fuel combustion using ammonium halides, will now be described in more detail with reference to the accompanying drawings.

FIG. 1 is a schematic block diagram of a first embodiment of a plant according to the subject disclosure for reducing flue gas mercury emissions using ammonium halides.

FIG. 2 is a schematic side cross sectional view of a first embodiment of equipment or apparatus for reducing mercury emissions using ammonium halides according to the plant of FIG. 1.

FIG. 3 is a schematic side cross sectional view of a second embodiment of equipment or apparatus for reducing mercury emissions using ammonium halides according to the plant of FIG. 1.

FIG. 4 is a schematic block diagram of a second embodiment of a plant according to the subject disclosure for reducing flue gas mercury emissions using ammonium halides.

FIG. 5 is a schematic side cross sectional view of a first embodiment of equipment or apparatus for reducing mercury emissions using ammonium halides according to the plant of FIG. 4.

FIG. 6 is a schematic side cross sectional view of a second embodiment of equipment or apparatus for reducing mercury emissions using ammonium halides according to the plant of FIG. 4.

FIG. 7A is a schematic perspective view of a sheet material used for manufacturing an embodiment of walls of a housing of equipment or apparatus for reducing mercury emissions using ammonium halides according to the plant of FIG. 1.

FIG. 7B is a schematic perspective view of a part of an embodiment of walls of a housing of equipment or apparatus for reducing mercury emissions using ammonium halides according to the plant of FIG. 1.

FIG. 8A is a schematic perspective view of a sheet material used for manufacturing an embodiment of walls of a housing of equipment or apparatus for reducing mercury emissions using ammonium halides according to the plant of FIG. 4.

FIG. 8B is a schematic perspective view of a part of an embodiment of walls of a housing of equipment or apparatus for reducing mercury emissions using ammonium halides according to the plant of FIG. 4.

### DETAILED DESCRIPTION

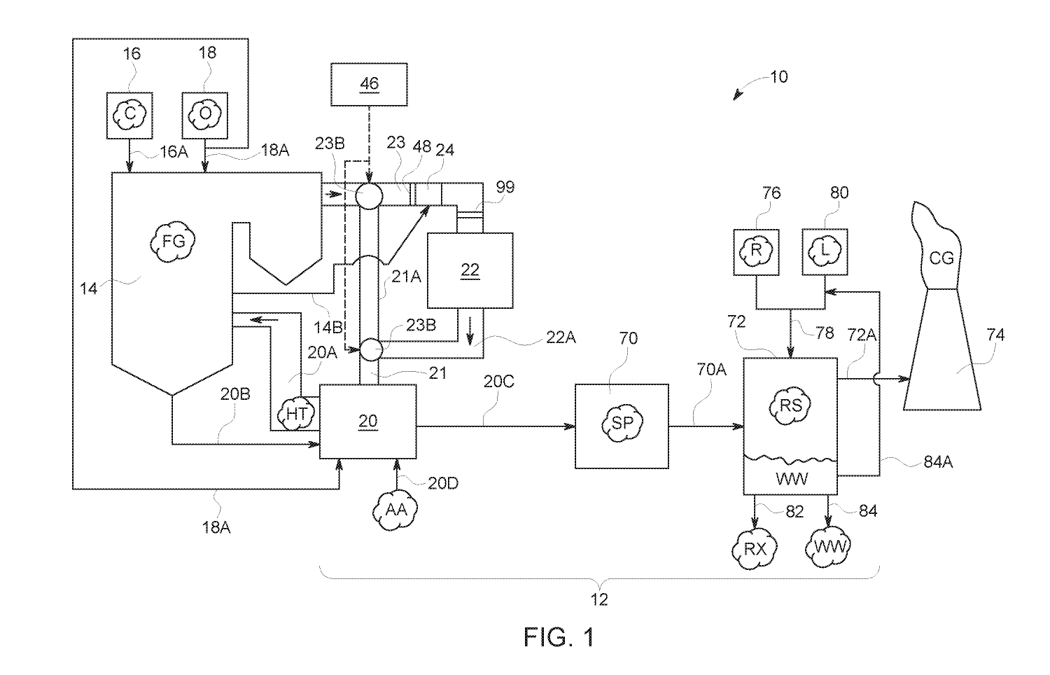

Illustrated in FIG. 1, is a plant 10 comprising equipment or apparatus 12 for the reduction of mercury emissions from coal combustion using ammonium halides. As such, the subject plant 10 includes a combustion unit 14 that combusts a fuel C from a fuel supply 16 to produce steam. Fuel C from fuel supply 16 is supplied to the combustion unit 14 via duct 16A. The produced steam may be supplied to a steam turbine (not shown) for use in generating electricity, or supplied elsewhere for other uses such as for example district heating, plant 10 process heating, or the like. The fuel C supplied to the combustion unit 14 can be coal, or another mercury-containing fuel. In the combustion of such a fuel C in the combustion unit 14, an oxygen-containing gas O, such as O₂ gas, air or another gas containing O₂ gas, may be supplied from an oxygen-containing gas supply 18 to the combustion unit 14 via a duct 18A. The combustion of fuel C in the presence of an oxygen-containing gas O within the combustion unit 14, in addition to producing steam, produces a flue gas FG. The produced flue gas FG flows from the combustion unit 14 to a fluidly connected nitrogen oxide reducing system 22 via duct 23.

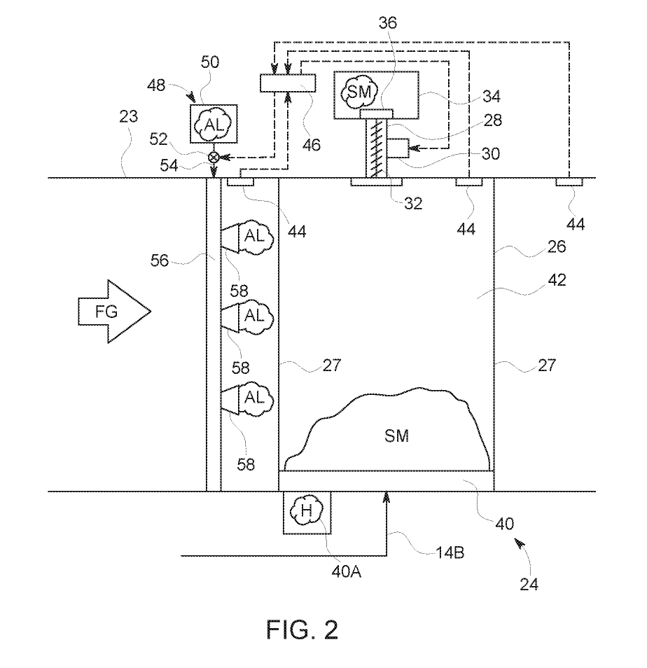

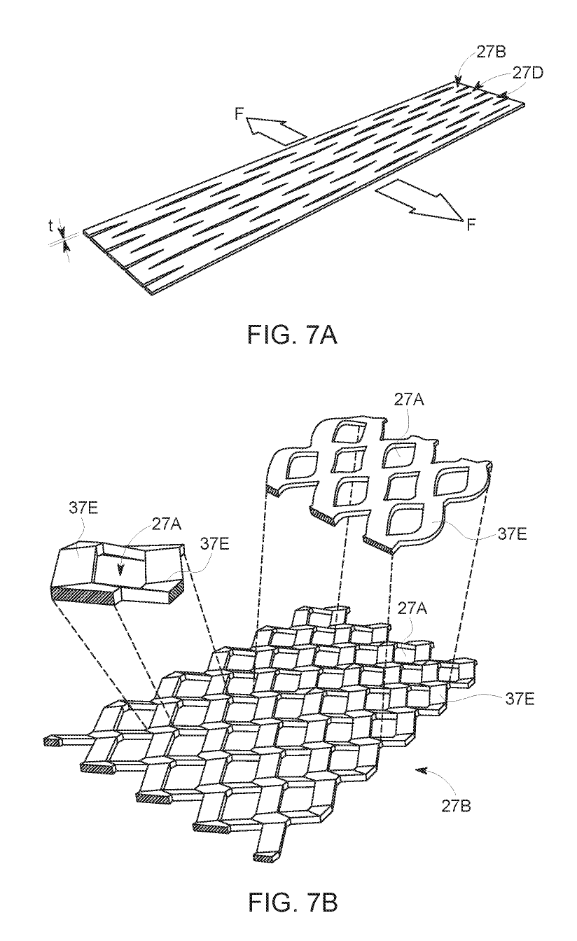

In a fixed arrangement within the duct 23 fluidly connecting the combustion unit 14 to the nitrogen oxide reducing system 22, is an ammonium halide decomposition apparatus or equipment 24. The ammonium halide decomposition apparatus or equipment 24, according to a first embodiment illustrated in an enlarged view in FIG. 2, comprises a perforated housing 26, a feeder 28 with a motor 30 mechanically driving conveyors 32 such as rotating paddles, rotating discs, a blower, or the like, operative to mechanically supply solid NH₄Br or solid NH₄Cl SM from a solid NH₄Br or solid NH₄Cl supply 34, through an outlet 36 of the a solid NH₄Br or solid NH₄Cl supply 34, through an inlet 38 of the perforated housing 26, to a heated base 40 arranged in interior area 42 within and defined by walls 27 of the perforated housing 26, one or more sensors 44 for measuring plant 10 operating parameters to obtain parameter measurements for electronic transmission of the parameter measurements to a control device 46 for receipt of the parameter measurements by the control device 46, and the control device 46 electronically operative via electronic signal to adjust operation of the motor 30 to affect feed rate of solid NH₄Br or solid NH₄Cl SM from the solid NH₄Br or solid NH₄Cl supply 34 to the interior area 42 of the perforated housing 26 based on the received parameter measurements. The solid NH₄Br or solid NH₄Cl SM supplied to the perforated housing 26 may be heated prior to such supply to the perforated housing 26. If the solid NH₄Br or solid NH₄Cl SM is heated prior to supply to the perforated housing 26, the solid NH₄Br or solid NH₄Cl SM is heated to a temperature below the particular ammonium halide sublimation temperature to avoid any possible decomposition of the solid NH₄Br or solid NH₄Cl SM prior to supply to the perforated housing 26. The solid NH₄Br or solid NH₄Cl SM supplied to the perforated housing 26 decomposes within the perforated housing 26 thereby releasing NH₃ and HBr or HCl to the flue gas FG flowing through the duct 23 for oxidation of elemental mercury)(Hg⁰) present in the flue gas FG, upstream of the nitrogen oxide reducing system 22. Heated base 40 may be heated by heat H from a heat source 40A, from combustion unit 14 via duct 14B, or from another source of heat. As such, heated base 40 is heated to a temperature of about 300° C. to about 490° C., or about 400° C., for decomposition of solid NH₄Br or solid NH₄Cl SM for the release of NH₃ and HBr or HCl to the flue gas FG. Walls 27 of perforated housing 26 comprise a plurality of perforations 27A for NH₃ and HBr or HCl flow from perforated housing 26 into duct 23 for intermixing with flue gas FG flowing through duct 23, and to the extent desired, flowing through perforated housing 26. Depending upon the extent of the desired flue gas FG flow through perforated housing 26 ranging from a maximized flue gas FG flow to a minimized or no flue gas FG flow, perforated housing 26 may be varied in size, perforation pattern, and/or arrangement within duct 23 to achieve the desired flue gas FG flow through the perforated housing 26. For example, to facilitate flue gas FG flow through perforated housing 26, walls 27 of perforated housing 26 may be constructed from a solid planar metal sheet 27B perforated or cut and stretched forming a “screen” with perforations 27A, as illustrated in FIGS. 7A and 7B described in more detail below. Alternatively, walls 27 of perforated housing 26 may be constructed of any suitably rigid material or sheet 27B perforated or cut to the extent desired to provide perforations 27A of any of one or more shapes, such as for example circular and/or square, through the sheet 27B for NH₃ and HBr or HCl flow from perforated housing 26 into duct 23 for intermixing with flue gas FG flowing through duct 23. Arranged separately upstream with regard to the flow of flue gas FG, arranged separately downstream with regard to the flow of flue gas FG, or arranged in combination with the ammonium halide decomposition apparatus or equipment 24 in duct 23, is an ammonia delivery system 48. Ammonia delivery system 48 comprises an ammonia supply 50 with a pump 52 operative for supplying ammonia AL to duct 23. As such, pump 52 pumps ammonia AL from ammonia supply 50 via pipe 54 to a spray lance 56 equipped with one or more fluidly connected nozzles 58, arranged within duct 23. Nozzles 58 are operative to spray ammonia AL within duct 23 for contact with flue gas FG flowing therethrough. Arranged downstream with regard to flue gas FG flow of the ammonium halide decomposition apparatus or equipment 24/ammonia delivery system 48 and upstream with regard to flue gas FG flow of the nitrogen oxide reducing system 22 is a gas mixing device 99, such as described in US2013/0188440 incorporated herein in its entirety by reference, for intermixing of NH₃, HBr or HCl, and flue gas FG.

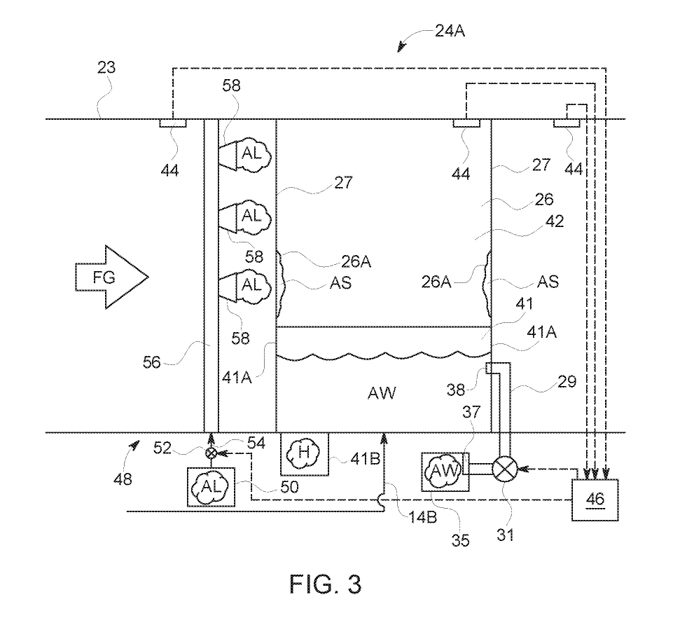

Alternatively, in a fixed arrangement within the duct 23 fluidly connecting the combustion unit 14 to the nitrogen oxide reducing system 22, is ammonium halide decomposition apparatus or equipment 24A. The ammonium halide decomposition apparatus or equipment 24A, according to a second embodiment illustrated in an enlarged view in FIG. 3, comprises a perforated housing 26, a feeder tube 29 with a pump 31 operative to mechanically supply a solution of NH₄Br or NH₄Cl dissolved in water AW from a NH₄Br or NH₄Cl and water solution supply 35 from an outlet 37 of the NH₄Br or NH₄Cl and water solution supply 35, through an inlet 38 of the housing 26, to a heated interior reservoir 41 defined by solid walls 41A fabricated as a part of or arranged within interior area 42 within and defined by walls 27 of the perforated housing 26, one or more sensors 44 for measuring plant 10 operating parameters to obtain parameter measurements for electronic transmission of the parameter measurements to a control device 46 for receipt of the parameter measurements by the control device 46, and the control device 46 electronically operative via electronic signal to adjust operation of the pump 31 to affect feed rate of the NH₄Br or NH₄Cl and water solution AW from the NH₄Br or NH₄Cl and water solution supply 35 to the heated interior reservoir 41 of the perforated housing 26 based on the received parameter measurements. The water from the NH₄Br or NH₄Cl and water solution AW supplied to the perforated housing 26 evaporates precipitating ammonium halide salts AS on surfaces 26A of the perforated housing 26. These precipitated ammonium halide salts AS decompose releasing NH₃ and HBr or HCl into the flue gas FG flowing through the duct 23 for oxidation of elemental mercury)(Hg⁰) present in the flue gas FG, upstream of the nitrogen oxide reducing system 22. The NH₄Br or NH₄Cl and water solution AW is an about 20 percent to about 70 percent, or an about 40 percent NH₄Br or NH₄Cl solution. Heated interior reservoir 41 may be heated by heat H from a heat source 41B, from combustion unit 14 via duct 14B, or from another source of heat. As such, heated interior reservoir 41 is heated to a temperature of about 300° C. to about 490° C., or about 400° C., for evaporation of the water and precipitation/decomposition of the ammonium halide salts AS from the NH₄Br or NH₄Cl and water solution AW for release of NH₃ and HBr or HCl into the flue gas FG. Walls 27 of perforated housing 26 comprise a plurality of perforations 27A for NH₃ and HBr or HCl flow from perforated housing 26 into duct 23 for intermixing with flue gas FG flowing through duct 23, and to the extent desired, flowing through perforated housing 26. Depending upon the extent of the desired flue gas FG flow through perforated housing 26 ranging from a maximized flue gas FG flow to a minimized or no flue gas FG flow, perforated housing 26 may be varied in size, perforation pattern, and/or arrangement within duct 23 to achieve the desired flue gas FG flow through the perforated housing 26. For example, to facilitate flue gas FG flow through perforated housing 26, walls 27 of perforated housing 26 may be constructed from a solid planar metal sheet 27B perforated or cut and stretched forming a “screen” with perforations 27A, as illustrated in FIGS. 7A and 7B described in more detail below. Alternatively, walls 27 of perforated housing 26 may be constructed of any suitably rigid material or sheet 27B perforated or cut to the extent desired to provide perforations 27A of any of one or more shapes, such as for example circular and/or square, through the sheet 27B for NH₃ and HBr or HCl flow from perforated housing 26 into duct 23 for intermixing with flue gas FG flowing through duct 23.

Arranged separately upstream with regard to the flow of flue gas FG, arranged separately downstream with regard to the flow of flue gas FG, or arranged in combination with the ammonium halide decomposition apparatus or equipment 24 in duct 23, is an ammonia delivery system 48. Ammonia delivery system 48 comprises an ammonia supply 50 with a pump 52 operative for supplying ammonia AL to duct 23. As such, pump 52 pumps ammonia AL from ammonia supply 50 via pipe 54 to a spray lance 56 equipped with one or more fluidly connected nozzles 58, arranged within duct 23. Nozzles 58 are operative to spray ammonia AL within duct 23 for contact with flue gas FG flowing therethrough. Arranged downstream with regard to flue gas FG flow of the ammonium halide decomposition apparatus or equipment 24/ammonia delivery system 48 and upstream with regard to flue gas FG flow of the nitrogen oxide reducing system 22 is a gas mixing device 99, such as described in US2013/0188440 incorporated herein in its entirety by reference, for intermixing of NH₃, HBr or HCl, and flue gas FG.

Walls 27 of perforated housing 26 may be produced from many different suitable materials, such as a metal. Examples of suitable metals are tempered sheet metal, such as sheet iron or sheet steel, e.g., HARDOX™ sheet steel commercially available from SSAB Svenskt Stal Aktiebolag Corporation, Sweden, or stainless materials. Stainless materials are especially well suited for use in the subject corrosive environments. By using metal to construct walls 27 a robust perforated housing 26 is achieved with a rather long lifetime. The non-flexible construction material of walls 27 may also be a ceramic material or a polymeric material, a kind of rigid plastics, such as TEFLON™ polymeric material commercially available from E.I. Du Pont De Nemours and Company Corporation, USA.

Walls 27 of housing 26 may be constructed from sheet metal as illustrated in FIGS. 7A and 7B. To construct walls 27, a shearing knife is used to create a pattern of cuts 27D perpendicularly with respect to a plane of metal sheet 27B, through the thickness t of the metal sheet 27B used to construct perforated housing 26. While creating cuts 27D or after cuts 27D have been created, the metal sheet 27B is stretched by application of opposing forces indicated in FIG. 7A by reference lettering “F” and arrows, thus deforming both the cuts 27D made by the knife, and the metal sheet 27B. This resultant deformation of metal sheet 27B, as illustrated in FIG. 7B, is a pattern of angled strands 37E with apertures 27A between the angled strands 37E. In other words, the angled strands 37E of the expanded metal sheet 27B are intermittently angled with respect to the plane of metal sheet 27B. These angled strands 37E give the expanded metal sheet 27B and hence walls 27 beneficial flue gas FG deflection properties to promote flue gas FG and NH₃ and HBr or HCl intermixing within perforated housing 26 and duct 23. Beneficial flue gas FG deflection properties are defined herein as a deflection or a turning of flue gas FG flow, apart from that of flue gas FG flow without such deflection or turning.

The nitrogen oxide reducing system 22 may be a selective catalytic reduction (SCR) system, a selective non-catalytic reduction (SNCR) system or another type of system configured to remove nitrogen oxides, e.g., NO₂, NO₃, NOₓ, from the flue gas FG. After removal of nitrogen oxides from the flue gas FG in the nitrogen oxide reducing system 22, the flue gas FG flows to a fluidly connected air preheater 20 via ducts 22A and 21. Duct 21 fluidly connects to duct 23 upstream with regard to flue gas FG flow of the ammonia delivery system 48, ammonium halide decomposition apparatus or equipment 24, and nitrogen oxide reducing system 22. As such, duct 21 fluidly connects to duct 23 and to air preheater 20. Devices 23B, such as adjustable valves or dampers, are arranged within ducts 23 and 22A at duct 21. Devices 23B may be adjusted to close duct 23 to prevent flue gas FG flow to the ammonia delivery system 48, ammonium halide decomposition apparatus or equipment 24, and nitrogen oxide reducing system 22, and to open a bypass portion 21A of duct 21 arranged between devices 23B. By closing duct 23 and opening bypass portion 21A of duct 21 using devices 23B, flue gas FG flowing through duct 23 is diverted to duct 21 for flue gas FG flow therethrough directly to air preheater 20. While duct 23 is closed to flue gas FG flow, maintenance or other adjustments may be made to ammonia delivery system 48, ammonium halide decomposition apparatus or equipment 24, and/or nitrogen oxide reducing system 22. Following maintenance or other adjustments being made to ammonia delivery system 48, ammonium halide decomposition apparatus or equipment 24, and/or nitrogen oxide reducing system 22, devices 23B may be adjusted to open duct 23 for flue gas FG flow to the ammonia delivery system 48, ammonium halide decomposition apparatus or equipment 24, and nitrogen oxide reducing system 22, and to close bypass portion 21A of duct 21 arranged between devices 23B. Adjustments to devices 23B may be made manually or electronically via control device 46. Following nitrogen oxide reducing system 22, flue gas FG flows via duct 22A into fluidly connected duct 21 upstream with regard to flue gas FG flow of air preheater 20.

From duct 21, flue gas FG flows into air preheater 20. If the air preheater 20 is operated with a recirculation of heat transfer fluid HT, heat energy from the relatively hot flue gas FG is transferred to the heat transfer fluid HT thereby cooling the relatively hot flue gas FG to obtain a relatively cool flue gas FG, while heating a relatively cool heat transfer fluid HT to obtain a relatively hot heat transfer fluid HT. The relatively hot heat transfer fluid HT flows from the air preheater 20 to the combustion unit 14 via duct 20A for beneficial use of the transferred heat energy in the combustion unit 14 for fuel C combustion and steam production. Following beneficial use of the transferred heat energy in the so combustion unit 14, the resulting relatively cool heat transfer fluid HT then circulates from the combustion unit 14 back to the air preheater 20 via duct 20B for reheating. The heat transfer fluid HT may be water, an oil, or a similar such heat retaining fluid. If the air preheater 20 is not operated with a recirculation of heat transfer fluid HT, such as in the case of the air preheater 20 being a regenerative rotating type heat exchanger, the heat transfer fluid HT, such as ambient air AA via duct 20D, an oxygen-containing gas O, such as O₂ gas or another gas containing O₂ gas supplied from an oxygen-containing gas supply 18 via a duct 18A, or the like, flows into the air preheater 20. Heat energy from the relatively hot flue gas FG is transferred to the heat transfer fluid HT thereby cooling the relatively hot flue gas FG to obtain a relatively cool flue gas FG, while heating the relatively cool heat transfer fluid HT to obtain a relatively hot heat transfer fluid HT. The relatively hot heat transfer fluid HT flows from the air preheater 20 to the combustion unit 14 via duct 20A for beneficial use of the transferred heat energy in the combustion unit 14 for fuel C combustion and steam production. Following beneficial use of the transferred heat energy HT in the combustion unit 14, the heat transfer fluid HT flows out of the combustion unit 14 with flue gas FG generated within the combustion unit 14 via duct 23. After flowing through the air preheater 20, the now relatively cool flue gas FG flows to a fluidly connected particulate collection system 70 via a duct 20C.

The particulate collection system 70 is arranged for flue gas FG flow therethrough for separation of solid particulates SP, such as combustion fly ash, dust, and the like, from the flue gas FG. Hence, oxidized mercury (Hg²⁺) adsorbed or precipitated onto combustion fly ash is separated as solid particulates SP from the flue gas FG. For such purpose, the particulate collection system 70 is a filter system or an electrostatic precipitator system. After the removal of solid particulates SP from the flue gas FG in the particulate collection system 70, the flue gas FG flows via a duct 70A into a wet flue gas desulfurization (WFGD) system 72.

Within the WFGD system 72, an alkaline reagent R such as lime, limestone, hydrated lime, sodium carbonate, trona, and/or alkaline fly ash from an alkaline reagent supply 76 via duct 78, and a liquid L such as water from a liquid supply 80 via duct 78 and/or recycled waste water supplied via ducts 84A and 78 are supplied as a reagent slurry RS for contact with the flue gas FG flowing therethrough. Such intermixing contact between the reagent slurry RS and the flue gas FG results in a reaction between acid gas such as hydrogen chloride (HCl), hydrogen fluoride (HF), sulfur dioxide (SO₂), sulfur trioxide (SO₃), and sulfuric acid (H₂SO₄), present in the flue gas FG and the reagent slurry RS. This reaction between the acid gas and the reagent slurry RS produces a solid reaction product RX such as calcium sulfite (CaSO₃), calcium sulfate (CaSO₄), calcium chloride (CaCl₂), and/or calcium fluoride (CaF₂), thereby removing acid gas from the flue gas FG. By so removing acid gas from the flue gas FG, flue gas FG acid gas emissions are reduced. Likewise, any remaining oxidized mercury (Hg²⁺) in the flue gas FG is removed from the flue gas FG by the reagent slurry RS, thereby reducing flue gas FG mercury emissions. After reducing acid gas and mercury in the flue gas FG, the so produced cleaned flue gas CG flows via a duct 72A from the WFGD system 72 to a stack 74 for environmentally conservative release to the environment from the stack 74. Reagent slurry RS used in the WFGD system 72 may be recirculated within the WFGD system 72 for repeated use, with solid reaction product RX continuously or periodically removed from the WFGD system 72 via duct 82 for use elsewhere within the plant 10, or for use in the production of gypsum wall board or the like. Waste water WW from WFGD system 72 may be continuously or periodically removed via duct 84 for supply to plant 10 equipment useful for eliminating waste water WW discharge or useful for other waste water WW treatment.

A method of using equipment or apparatus 24 for the reduction of mercury emissions from coal combustion using ammonium halides comprises fixedly arranging within a duct 23 upstream of a nitrogen oxide reducing system 22 a perforated housing 26 measuring plant 10 operating parameters using one or more sensors 44 to obtain parameter measurements electronically transmitted to a control device 46 for receipt of the parameter measurements by the control device 46, adjusting through control device 46 electronic signal a supply rate of solid NH₄Br or solid NH₄Cl SM to the perforated housing 26 based on parameter measurements received by the control device 46, supplying via a feeder 28 the solid NH₄Br or solid NH₄Cl SM to a heated base 40 in interior area 42 of the perforated housing 26 at the supply rate, decomposing the solid NH₄Br or solid NH₄Cl SM in the perforated housing 26 for release of NH₃ and HBr and/or HCl from the perforated housing 26 into flue gas FG flowing through the duct 23 for oxidation of elemental mercury)(Hg⁰) present in the flue gas FG to produce oxidized mercury (Hg²⁺) prior to flue gas FG flow into the nitrogen oxide reducing system 22, and removing precipitated oxidized mercury (Hg²⁺) in a particulate collection system 70 to reduce mercury emissions.

Another method of using equipment or apparatus 24A for the reduction of mercury emissions from coal combustion using ammonium halides comprises fixedly arranging within a duct 23 upstream of a nitrogen oxide reducing system 22 a perforated housing 26, measuring plant operating parameters using one or more sensors 44 to obtain parameter measurements electronically transmitted to a control device 46 for receipt of the parameter measurements by the control device 46, adjusting through control device 46 electronic signal a supply rate of a NH₄Br or NH₄Cl and water solution AW to an interior reservoir 41 of the perforated housing 26 based on the received parameter measurements, supplying the NH₄Br or NH₄Cl and water solution AW to the interior reservoir 41 within the perforated housing 26 at the supply rate, evaporating water from the NH₄Br or NH₄Cl and water solution AW for ammonium halide salt AS precipitation within the perforated housing 26, decomposing the precipitated ammonium halide salt AS for release of NH₃ and HBr and/or HCl from the perforated housing 26 into flue gas FG flowing through the duct 23 for oxidation of elemental mercury) (Hg⁰) present in the flue gas FG to produce oxidized mercury (Hg²⁺) prior to flue gas FG flow into the nitrogen oxide reducing system 22, and removing precipitated oxidized mercury (Hg²⁺) in a particulate collection system 70 to reduce mercury emissions.

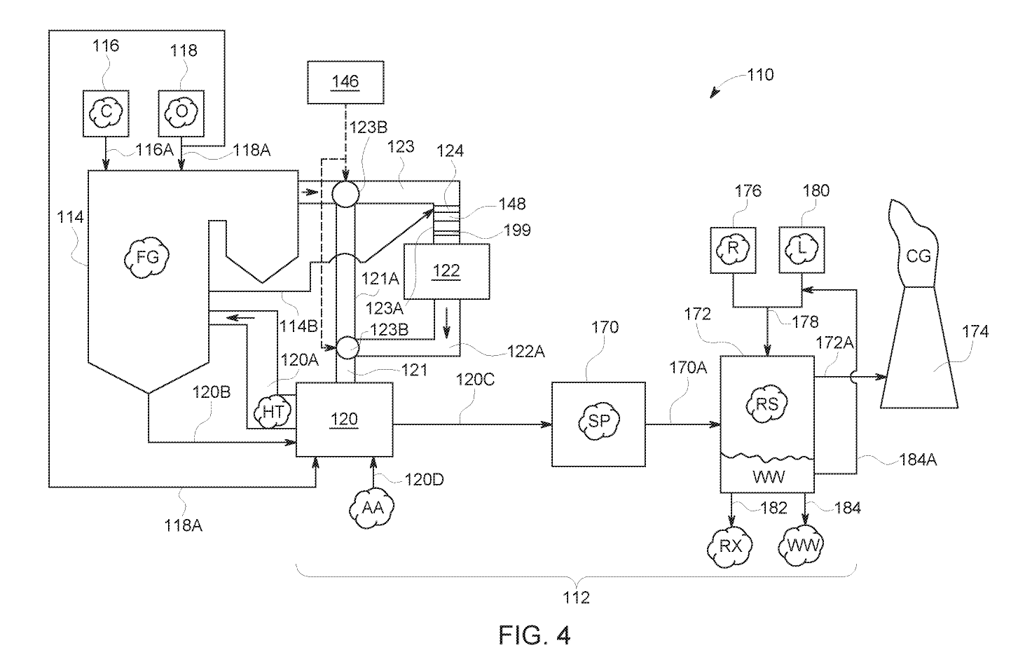

Illustrated in FIG. 4, is a plant 110 comprising equipment or apparatus 112 for the reduction of mercury emissions from coal combustion using ammonium halides. As such, the subject plant 110 includes a combustion unit 114 that combusts a fuel C from a fuel supply 116 to produce steam. Fuel C from fuel supply 116 is supplied to the combustion unit 114 via duct 116A. The produced steam may be supplied to a steam turbine (not shown) for use in generating electricity, or supplied elsewhere for other uses such as for example district heating, plant 110 process heating, or the like. The fuel C supplied to the combustion unit 114 can be coal, or another mercury-containing fuel. In the combustion of such a fuel C in the combustion unit 114, an oxygen-containing gas O, such as O₂ gas, air or another gas containing O₂ gas, may be supplied from an oxygen-containing gas supply 118 to the combustion unit 114 via a duct 118A. The combustion of fuel C in the presence of an oxygen-containing gas O within the combustion unit 114, in addition to producing steam, produces a flue gas FG. The produced flue gas FG flows from the combustion unit 114 to a fluidly connected nitrogen oxide reducing system 122 via duct 123 comprising a vertical portion 123A.

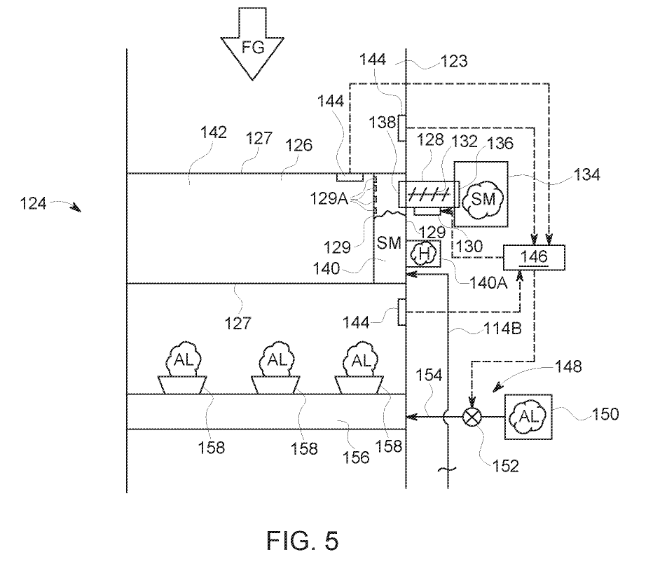

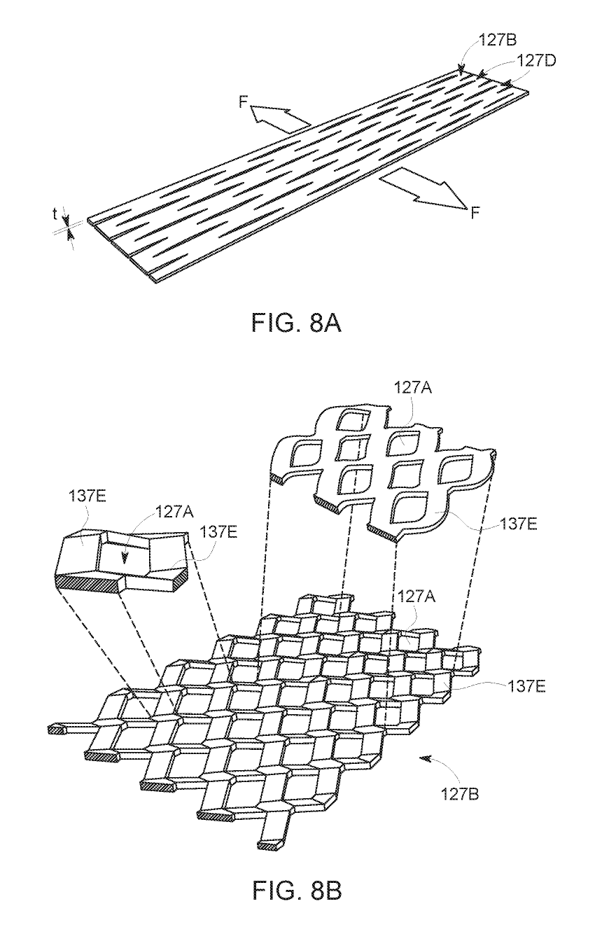

In a fixed arrangement within the vertical portion 123A of duct 123 fluidly connecting the combustion unit 114 to the nitrogen oxide reducing system 122, is an ammonium halide decomposition apparatus or equipment 124. The ammonium halide decomposition apparatus or equipment 124, according to a first embodiment illustrated in an enlarged view in FIG. 5, comprises a perforated housing 126, a feeder 128 with a motor 130 mechanically driving conveyors 132 such as rotating paddles, rotating discs, a blower, or the like, operative to mechanically supply solid NH₄Br or solid NH₄Cl SM from a solid NH₄Br or solid NH₄Cl supply 134, through an outlet 136 of the a solid NH₄Br or solid NH₄Cl supply 134, through an inlet 138 of the perforated housing 126, to a heated vessel 140 arranged in interior area 142 within and defined by horizontal walls 127 of the perforated housing 126 and vertical walls 129, one or more sensors 144 for measuring plant 110 operating parameters to obtain parameter measurements for electronic transmission of the parameter measurements to a control device 146 for receipt of the parameter measurements by the control device 146, and the control device 146 electronically operative via electronic signal to adjust operation of the motor 130 to affect feed rate of solid NH₄Br or solid NH₄Cl SM from the solid NH₄Br or solid NH₄Cl supply 134 to the interior area 142 of the perforated housing 126 based on the received parameter measurements. The solid NH₄Br or solid NH₄Cl SM supplied to the perforated housing 126 may be heated prior to such supply to the perforated housing 126. If the solid NH₄Br or solid NH₄Cl SM is heated prior to supply to the perforated housing 126, the solid NH₄Br or solid NH₄Cl SM is heated to a temperature below the particular ammonium halide sublimation temperature to avoid any possible decomposition of the solid NH₄Br or solid NH₄Cl SM prior to supply to the perforated housing 126. The solid NH₄Br or solid NH₄Cl SM supplied to the perforated housing 126 decomposes within the perforated housing 126 thereby releasing NH₃ and HBr or HCl to the flue gas FG flowing through the duct 23 for oxidation of elemental mercury)(Hg⁰) present in the flue gas FG, upstream of the nitrogen oxide reducing system 122. Heated vessel 140 may be heated by heat H from a heat source 140A, from combustion unit 114 via duct 114B, or from another source of heat. As such, heated vessel 140 is heated to a temperature of about 300° C. to about 490° C., or about 400° C., for decomposition of solid NH₄Br or solid NH₄Cl SM for the release of NH₃ and HBr or HCl to the flue gas FG. Horizontal walls 127 of perforated housing 126 comprise a plurality of perforations 127A for NH₃ and HBr or HCl flow from perforated housing 126 into duct 123 for intermixing with flue gas FG flowing through duct 123, and to the extent desired, flowing through perforated housing 126. Depending upon the extent of the desired flue gas FG flow through perforated housing 126 ranging from a maximized flue gas FG flow to a minimized or no flue gas FG flow, perforated housing 126 may be varied in size, perforation pattern, and/or arrangement within duct 123 to achieve the desired flue gas FG flow through the perforated housing 126. For example, to facilitate flue gas FG flow through perforated housing 126, horizontal walls 127 of perforated housing 126 may be constructed from a solid planar metal sheet 127B perforated or cut and stretched forming a “screen” with perforations 127A, as illustrated in FIGS. 8A and 8B described in more detail below. Alternatively, walls 127 of perforated housing 126 may be constructed of any suitable rigid material or sheet 127B perforated or cut to the extent desired to provide perforations 27A of any of one or more shapes, such as for example circular or square, through the sheet 127B for NH3 and HBr or HCl flow from perforated housing 126 into duct 123 for intermixing with flue gas FG flow through duct 123. Likewise, at least a portion of vertical wall 129 in interior area 142 of perforated housing 126 comprises a plurality of perforations 129A for flow of NH₃ and HBr or HCl from heated vessel 140 into interior area 142 of perforated housing 126 for intermixing with flue gas FG. Arranged separately upstream with regard to the flow of flue gas FG, arranged separately downstream with regard to the flow of flue gas FG, or arranged in combination with the ammonium halide decomposition apparatus or equipment 124 in duct 123, is an ammonia delivery system 148. Ammonia delivery system 148 comprises an ammonia supply 150 with a pump 152 operative for supplying ammonia AL to duct 123. As such, pump 152 pumps ammonia AL from ammonia supply 150 via pipe 154 to a spray lance 156 equipped with one or more fluidly connected nozzles 158, arranged within duct 123. Nozzles 158 are operative to spray ammonia AL within duct 123 for contact with flue gas FG flowing therethrough. Arranged downstream with regard to flue gas FG flow of the ammonium halide decomposition apparatus or equipment 124/ammonia delivery system 148 and upstream with regard to flue gas FG flow of the nitrogen oxide reducing system 122 is a gas mixing device 199, such as described in US2013/0188440 incorporated herein in its entirety by reference, for intermixing of NH₃, HBr or HCl, and flue gas FG.

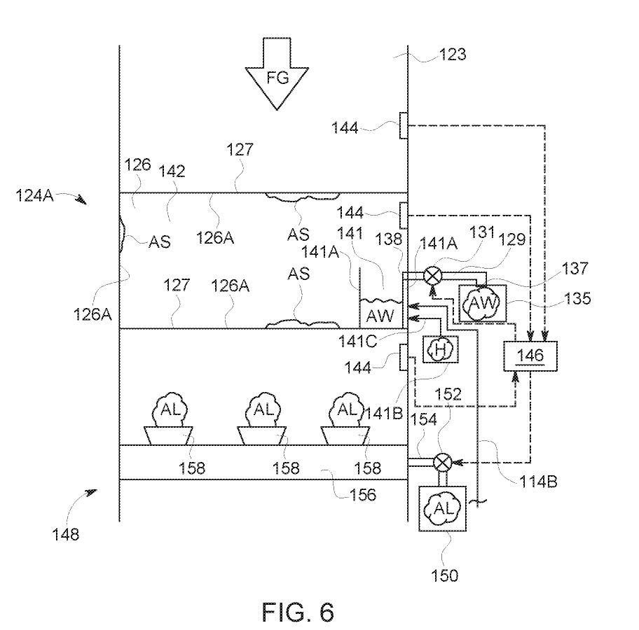

Alternatively, in a fixed arrangement within the vertical portion 123A of duct 123 fluidly connecting the combustion unit 114 to the nitrogen oxide reducing system 122, is ammonium halide decomposition apparatus or equipment 124A. The ammonium halide decomposition apparatus or equipment 124A, according to a second embodiment illustrated in an enlarged view in FIG. 6, comprises a perforated housing 126, a feeder tube 129 with a pump 131 operative to mechanically supply a solution of NH₄Br or NH₄Cl dissolved in water AW from a NH₄Br or NH₄Cl and water solution supply 135 from an outlet 137 of the NH₄Br or NH₄Cl and water solution supply 135, through an inlet 138 of the housing 126, to a heated interior reservoir 141 defined by at least partially solid walls 141A fabricated as a part of or arranged within interior area 142 within and defined by walls 127 of the perforated housing 126, one or more sensors 144 for measuring plant 110 operating parameters to obtain parameter measurements for electronic transmission of the parameter measurements to a control device 146 for receipt of the parameter measurements by the control device 146, and the control device 146 electronically operative via electronic signal to adjust operation of the pump 131 to affect feed rate of the NH₄Br or NH₄Cl and water solution AW from the NH₄Br or NH₄Cl and water solution supply 135 to the heated interior reservoir 141 of the perforated housing 126 based on the received parameter measurements. The water from the NH₄Br or NH₄Cl and water solution AW supplied to the perforated housing 126 evaporates precipitating ammonium halide salts AS on surfaces 126A of the perforated housing 126. These precipitated ammonium halide salts AS decompose releasing NH₃ and HBr or HCl into the flue gas FG flowing through the duct 123 for oxidation of elemental mercury)(Hg⁰) present in the flue gas FG, upstream of the nitrogen oxide reducing system 122. The NH₄Br or NH₄Cl and water solution AW is an about 20 percent to about 70 percent, or an about 40 percent NH₄Br or NH₄Cl solution. Heated interior reservoir 141 may be heated by heat H from a heat source 141B via duct 141C, from combustion unit 114 via duct 114B, or from another source of heat. As such, heated interior reservoir 141 is heated to a temperature of about 300° C. to about 490° C., or about 400° C., for evaporation of the water and precipitation/decomposition of the ammonium halide salts AS from the NH₄Br or NH₄Cl and water solution AW for release of NH₃ and HBr or HCl into the flue gas FG. Walls 127 of perforated housing 126 comprise a plurality of perforations 127A for NH3 and HBr or HCl flow from perforated housing 126 into duct 123 for intermixing with flue gas FG flowing through duct 123, and to the extent desired, flowing through perforated housing 126. Depending upon the extent of the desired flue gas FG flow through perforated housing 126 ranging from a maximized flue gas FG flow to a minimized or no flue gas FG flow, perforated housing 126 may be varied in size, perforation pattern, and/or arrangement within duct 123 to achieve the desired flue gas FG flow through the perforated housing 126. For example, to facilitate flue gas FG flow through perforated housing 126, walls 127 of perforated housing 126 may be constructed from a solid planar metal sheet 127B perforated or cut and stretched forming a “screen” with perforations 127A, as illustrated in FIGS. 8A and 8B described in more detail below. Alternatively, walls 127 of perforated housing 126 may be constructed of any suitably rigid material or sheet 127B perforated or cut to the extent desired to provide perforations 127A of any of one or more shapes, such as for example circular or square, through the sheet 127B for NH₃ and HBr or HCl flow from perforated housing 126 into duct 123 for intermixing with flue gas FG flowing through duct 123.

Arranged separately upstream with regard to the flow of flue gas FG, arranged separately downstream with regard to the flow of flue gas FG, or arranged in combination with the ammonium halide decomposition apparatus or equipment 124 in vertical portion 123A of duct 123, is an ammonia delivery system 148. Ammonia delivery system 148 comprises an ammonia supply 150 with a pump 152 operative for supplying ammonia AL to duct 123. As such, pump 152 pumps ammonia AL from ammonia supply 150 via pipe 154 to a spray lance 156 equipped with one or more fluidly connected nozzles 158, arranged within duct 123. Nozzles 158 are operative to spray ammonia AL within duct 123 for contact with flue gas FG flowing therethrough. Arranged downstream with regard to flue gas FG flow of the ammonium halide decomposition apparatus or equipment 124/ammonia delivery system 148 and upstream with regard to flue gas FG flow of the nitrogen oxide reducing system 122 is a gas mixing device 199, such as described in US2013/0188440 incorporated herein in its entirety by reference, for intermixing of NH₃, HBr or HCl, and flue gas FG.

Walls 127 of perforated housing 126 may be produced from many different suitable materials, such as a metal. Examples of suitable metals are tempered sheet metal, such as sheet iron or sheet steel, e.g., HARDOX™ sheet steel commercially available from SSAB Svenskt Stal Aktiebolag Corporation, Sweden, or stainless materials. Stainless materials are especially well suited for use in the subject corrosive environments. By using metal to construct walls 127 a robust perforated housing 126 is achieved with a rather long lifetime. The non-flexible construction material of walls 127 may also be a ceramic material or a polymeric material, a kind of rigid plastics, such as TEFLON™ polymeric material commercially available from E.I. Du Pont De Nemours and Company Corporation, USA.

Walls 127 of housing 126 may be constructed from sheet metal as illustrated in FIGS. 8A and 8B. To construct walls 127, a shearing knife is used to create a pattern of cuts 127D perpendicularly with respect to a plane of metal sheet 127B, through the thickness t of the metal sheet 127B used to construct perforated housing 126. While creating cuts 127D or after cuts 127D have been created, the metal sheet 127B is stretched by application of opposing forces indicated in FIG. 8A by reference lettering “F” and arrows, thus deforming both the cuts 127D made by the knife, and the metal sheet 127B. This resultant deformation of metal sheet 127B, as illustrated in FIG. 8B, is a pattern of angled strands 137E with apertures 127A between the angled strands 137E. In other words, the angled strands 137E of the expanded metal sheet 127B are intermittently angled with respect to the plane of metal sheet 127B. These angled strands 137E give the expanded metal sheet 127B and hence walls 127 beneficial flue gas FG deflection properties to promote flue gas FG and NH₃ and HBr or HCl intermixing within duct 123. Beneficial flue gas FG deflection properties are defined herein as a deflection or a turning of flue gas FG flow, apart from that of flue gas FG flow without such deflection or turning.

The nitrogen oxide reducing system 122 may be a selective catalytic reduction (SCR) system, a selective non-catalytic reduction (SNCR) system or another type of system configured to remove nitrogen oxides, e.g., NO₂, NO₃, NOₓ, from the flue gas FG. After removal of nitrogen oxides from the flue gas FG in the nitrogen oxide reducing system 122, the flue gas FG flows to a fluidly connected air preheater 120 via ducts 122A and 121. Duct 121 fluidly connects to duct 123 upstream with regard to flue gas FG flow of the ammonium halide decomposition apparatus or equipment 124, ammonia delivery system 148, and nitrogen oxide reducing system 122. As such, duct 121 fluidly connects to duct 123 and to air preheater 120. Devices 123B, such as adjustable valves or dampers, are arranged within ducts 123 and 122A at duct 121. Devices 123B may be adjusted to close duct 123 to prevent flue gas FG flow to the ammonium halide decomposition apparatus or equipment 124, ammonia delivery system 148, and nitrogen oxide reducing system 122, and to open a bypass portion 121A of duct 121 arranged between devices 123B. By closing duct 123 and opening bypass portion 121A of duct 121 using devices 123B, flue gas FG flowing through duct 123 is diverted to duct 121 for flue gas FG flow therethrough directly to air preheater 120. While duct 123 is closed to flue gas FG flow, maintenance or other adjustments may be made to ammonium halide decomposition apparatus or equipment 124, ammonia delivery system 148, and/or nitrogen oxide reducing system 122. Following maintenance or other adjustments being made to ammonium halide decomposition apparatus or equipment 124, ammonia delivery system 148, and/or nitrogen oxide reducing system 122, devices 123B may be adjusted to open duct 123 for flue gas FG flow to the ammonium halide decomposition apparatus or equipment 124, ammonia delivery system 148, and nitrogen oxide reducing system 122, and to close bypass portion 121A of duct 121 arranged between devices 123B. Adjustments to devices 123B may be made manually or electronically via control device 146. Following nitrogen oxide reducing system 122, flue gas FG flows via duct 122A into fluidly connected duct 121 upstream with regard to flue gas FG flow of air preheater 120.

From duct 121, flue gas FG flows into air preheater 120. If the air preheater 120 is operated with a recirculation of heat transfer fluid HT, heat energy from the relatively hot flue gas FG is transferred to the heat transfer fluid HT thereby cooling the relatively hot flue gas FG to obtain a relatively cool flue gas FG, while heating a relatively cool heat transfer fluid HT to obtain a relatively hot heat transfer fluid HT. The relatively hot heat transfer fluid HT flows from the air preheater 120 to the combustion unit 114 via duct 120A for beneficial use of the transferred heat energy in the combustion unit 114 for fuel C combustion and steam production. Following beneficial use of the transferred heat energy in the combustion unit 114, the resulting relatively cool heat transfer fluid HT then circulates from the combustion unit 114 back to the air preheater 120 via duct 120B for reheating. The heat transfer fluid HT may be water, an oil, or a similar such heat retaining fluid. If the air preheater 120 is not operated with a recirculation of heat transfer fluid HT, such as in the case of the air preheater 120 being a regenerative rotating type heat exchanger, the heat transfer fluid HT, such as ambient air AA via duct 120D, an oxygen-containing gas O, such as O₂ gas or another gas containing O₂ gas supplied from an oxygen-containing gas supply 118 via a duct 118A, or the like, flows into the air preheater 120. Heat energy from the relatively hot flue gas FG is transferred to the heat transfer fluid HT thereby cooling the relatively hot flue gas FG to obtain a relatively cool flue gas FG, while heating the relatively cool heat transfer fluid HT to obtain a relatively hot heat transfer fluid HT. The relatively hot heat transfer fluid HT flows from the air preheater 120 to the combustion unit 114 via duct 120A for beneficial use of the transferred heat energy in the combustion unit 114 for fuel C combustion and steam production. Following beneficial use of the transferred heat energy HT in the combustion unit 114, the heat transfer fluid HT flows out of the combustion unit 114 with flue gas FG generated within the combustion unit 114 via duct 123. After flowing through the air preheater 120, the now relatively cool flue gas FG flows to a fluidly connected particulate collection system 170 via a duct 120C.

The particulate collection system 170 is arranged for flue gas FG flow therethrough for separation of solid particulates SP, such as combustion fly ash, dust, and the like, from the flue gas FG. Hence, oxidized mercury (Hg²⁺) adsorbed or precipitated onto combustion fly ash is separated as solid particulates SP from the flue gas FG. For such purpose, the particulate collection system 170 is a filter system or an electrostatic precipitator system. After the removal of solid particulates SP from the flue gas FG in the particulate collection system 170, the flue gas FG flows via a duct 170A into a wet flue gas desulfurization (WFGD) system 172.

Within the WFGD system 172, an alkaline reagent R such as lime, limestone, hydrated lime, sodium carbonate, trona, and/or alkaline fly ash from an alkaline reagent supply 176 via duct 178, and a liquid L such as water from a liquid supply 180 via duct 178 and/or recycled waste water supplied via ducts 184A and 178 are supplied as a reagent slurry RS for contact with the flue gas FG flowing therethrough. Such intermixing contact between the reagent slurry RS and the flue gas FG results in a reaction between acid gas such as hydrogen chloride (HCl), hydrogen fluoride (HF), sulfur dioxide (SO₂), sulfur trioxide (SO₃), and sulfuric acid (H₂SO₄), present in the flue gas FG and the reagent slurry RS. This reaction between the acid gas and the reagent slurry RS produces a solid reaction product RX such as calcium sulfite (CaSO₃), calcium sulfate (CaSO₄), calcium chloride (CaCl₂), and/or calcium fluoride (CaF₂), thereby removing acid gas from the flue gas FG. By so removing acid gas from the flue gas FG, flue gas FG acid gas emissions are reduced. Likewise, any remaining oxidized mercury (Hg²⁺) in the flue gas FG is removed from the flue gas FG by the reagent slurry RS, thereby reducing flue gas FG mercury emissions. After reducing acid gas and mercury in the flue gas FG, the so produced cleaned flue gas CG flows via a duct 172A from the WFGD system 172 to a stack 174 for environmentally conservative release to the environment from the stack 174. Reagent slurry RS used in the WFGD system 172 may be recirculated within the WFGD system 172 for repeated use, with solid reaction product RX continuously or periodically removed from the WFGD system 172 via duct 182 for use elsewhere within the plant 110, or for use in the production of gypsum wall board or the like. Waste water WW from WFGD system 172 may be continuously or periodically removed via duct 184 for supply to plant 110 equipment useful for eliminating waste water WW discharge or useful for other waste water WW treatment.

A method of using equipment or apparatus 124 for the reduction of mercury emissions from coal combustion using ammonium halides comprises fixedly arranging within a vertical portion 123A of duct 123 upstream of a nitrogen oxide reducing system 122 a perforated housing 126 measuring plant 110 operating parameters using one or more sensors 144 to obtain parameter measurements electronically transmitted to a control device 146 for receipt of the parameter measurements by the control device 146, adjusting through control device 146 electronic signal a supply rate of solid NH₄Br or solid NH₄Cl SM to the perforated housing 126 based on parameter measurements received by the control device 146, supplying via a feeder 128 the solid NH₄Br or solid NH₄Cl SM to a heated base 140 in interior area 142 of the perforated housing 126 at the supply rate, decomposing the solid NH₄Br or solid NH₄Cl SM in the perforated housing 126 for release of NH₃ and HBr and/or HCl from the perforated housing 126 into flue gas FG flowing through duct 123 for oxidation of elemental mercury) (Hg⁰) present in the flue gas FG to produce oxidized mercury (Hg²⁺) prior to flue gas FG flow into the nitrogen oxide reducing system 122, and removing precipitated oxidized mercury (Hg²⁺) in a particulate collection system 170 to reduce mercury emissions.

Another method of using equipment or apparatus 124A for the reduction of mercury emissions from coal combustion using ammonium halides comprises fixedly arranging within a vertical portion 123A of duct 123 upstream of a nitrogen oxide reducing system 122 a perforated housing 126, measuring plant operating parameters using one or more sensors 144 to obtain parameter measurements electronically transmitted to a control device 146 for receipt of the parameter measurements by the control device 146, adjusting through control device 146 electronic signal a supply rate of a NH₄Br or NH₄Cl and water solution AW to an interior reservoir 141 of the perforated housing 126 based on the received parameter measurements, supplying the NH₄Br or NH₄Cl and water solution AW to the interior reservoir 141 within the perforated housing 126 at the supply rate, evaporating water from the NH₄Br or NH₄Cl and water solution AW for ammonium halide salt AS precipitation within the perforated housing 126, decomposing the precipitated ammonium halide salt AS for release of NH₃ and HBr and/or HCl from the perforated housing 126 into flue gas FG flowing through duct 123 for oxidation of elemental mercury)(Hg⁰) present in the flue gas FG to produce oxidized mercury (Hg²⁺) prior to flue gas FG flow into the nitrogen oxide reducing system 122, and removing precipitated oxidized mercury (Hg²⁺) in a particulate collection system 170 to reduce mercury emissions.

In summary, disclosed herein is an apparatus 12, 112 for flue gas FG mercury emissions reduction that comprises a perforated housing 26, 126 arranged within a duct 23, 123 for a flow of a mercury-containing flue gas FG through the duct 23, 123, an ammonium halide supply 34, 134 supplying ammonium halide SM, AW to a heated interior area 42, 142 of the perforated housing 26, 126, heated to a temperature of ammonium halide SM, AW decomposition, one or more sensors 44, 144 for measuring operating parameters within the duct 23, 123 and/or perforated housing 26, 126 to obtain parameter measurements electronically transmitted to a control device 46, 146, and the control device 46, 146 based on received parameter measurements adjusting through electronic signal a rate of supply of the ammonium halide SM, AW, GS from the ammonium halide supply 34, 134 to the heated interior area 42, 142 of the perforated housing 26, 126, wherein within the heated interior area 42, 142 of the perforated housing 26, 126 the ammonium halide SM, AW decomposes releasing NH₃ and HBr or HCl for oxidation of elemental mercury to obtain oxidized mercury for separation from the mercury-containing flue gas FG. The apparatus 12, 112 further comprises an ammonia delivery system 48, 148 supplying a spray of ammonia AL within the duct 23, 123 and into the flow of mercury-containing flue gas FG through the duct 23, 123. The heated interior area 42, 142 of the perforated housing 26, 126 is heated to a temperature of about 300° C. to about 490° C., or about 400° C. The ammonium halide supply 34, 134 supplies a solid ammonium halide SM, or an ammonium halide solution AW to the heated interior area 42, 142 of the perforated housing 26, 126. As such, the ammonium halide supply 34, 134 may supply an about 20 percent to about 70 percent, or an about 40 percent ammonium halide solution AW to the heated interior area 42, 142 of the perforated housing 26, 126. The apparatus 12, 112 duct 23, 123 may comprise a vertical portion 123A, and the perforated housing 26, 126 may be manufactured from a cut and expanded metal sheet 27B, 127B. The apparatus 12, 112 may further comprise a particulate collection system 70, 170 and/or wet flue gas desulfurization system 72, 172 for separating the oxidized mercury from the flue gas FG.

In summary, disclosed herein is a method for flue gas FG mercury emissions reduction that comprises arranging a perforated housing 26, 126 within a duct 23, 123 for a flow of a mercury-containing flue gas FG through the duct 23, 123, supplying an ammonium halide SM, AW from an ammonium halide supply 34, 134 to a heated interior area 42, 142 of the perforated housing 26, 126 heated to a temperature of ammonium halide SM, AW decomposition, measuring with one or more sensors 44, 144 operating parameters within the duct 23, 123 and/or perforated housing 26, 126 to obtain parameter measurements electronically transmitted to a control device 46, 146, adjusting through electronic signal from the control device 46, 146 a rate of supply of the ammonium halide SM, AW from the ammonium halide supply 34, 134 to the heated interior area 42, 142 of the perforated housing 26, 126 based on control device 46, 146 received parameter measurements, and releasing NH₃ and HBr or HCl through decomposition of the ammonium halide SM, AW for oxidation of elemental mercury present in the mercury-containing flue gas FG to obtain oxidized mercury for separation from the mercury-containing flue gas FG. The method further comprises supplying a spray of ammonia AL within the duct 23, 123 and into the flow of mercury-containing flue gas FG through the duct 23, 123. The heated interior area 42, 142 of the perforated housing 26, 126 is heated to a temperature of about 300° C. to about 490° C., or about 400° C. The ammonium halide SM, AW supplied to the perforated housing 26, 126 may be a solid ammonium halide SM or an ammonium halide solution AW. As such, the ammonium halide SM, AW supplied to the perforated housing 26, 126 may be an about 20 percent to about 70 percent, or an about 40 percent ammonium halide solution AW. Further, the duct 23, 123 may comprise a vertical portion 123A. The perforated housing 26, 126 according to the method may be manufactured from a cut and expanded metal sheet 27B, 127B. Also, the method may further comprise separating the oxidized mercury from the flue gas FG using a particulate collection system 70, 170 and/or a wet flue gas desulfurization system 72, 172.

While the subject matter of this disclosure has been described with reference to various exemplified embodiments, it will be understood by those skilled in the art that various changes may be made and equivalents may be substituted for features thereof without departing from the intended spirit and scope. In addition, many modifications may be made to adapt a particular situation or material to the teachings of this disclosure without departing from the essential scope thereof. Therefore, it is intended that this disclosure not be limited to the particular embodiments described, but rather include all embodiments falling within the scope of the appended claims.

1. An apparatus for flue gas mercury emissions reduction comprising:
a perforated housing arranged within a duct for a flow of a mercury-containing flue gas through the duct;
an ammonium halide supply supplying ammonium halide to a heated interior area of the perforated housing, heated to a temperature of ammonium halide decomposition;
one or more sensors for measuring operating parameters within the so duct and/or perforated housing to obtain parameter measurements electronically transmitted to a control device; and
the control device based on received parameter measurements adjusting through electronic signal a rate of supply of the ammonium halide from the ammonium halide supply to the heated interior area of the perforated housing;
wherein within the heated interior area of the perforated housing the ammonium halide decomposes releasing NH₃ and HBr or HCl for oxidation of elemental mercury to obtain oxidized mercury for separation from the mercury-containing flue gas.

2. The apparatus of claim 1, further comprising an ammonia delivery system supplying a spray of ammonia within the duct and into the flow of mercury-containing flue gas through the duct.

3. The apparatus of claim 1, wherein the heated interior area of the perforated housing is heated to a temperature of about 300° C. to about 490° C.

4. The apparatus of claim 1, wherein the ammonium halide supply supplies a solid ammonium halide or an ammonium halide solution to the heated interior area of the perforated housing.

5. The apparatus of claim 1, wherein the ammonium halide supply supplies an about 20 percent to about 70 percent ammonium halide solution to the heated interior area of the perforated housing.

6. The apparatus of claim 1, wherein the duct comprises a vertical portion in which the perforated housing is arranged.

7. The apparatus of claim 1, wherein the perforated housing is manufactured from a cut and expanded metal sheet.

8. The apparatus of claim 1, further comprising a particulate collection system and/or wet flue gas desulfurization system for separating the oxidized mercury from the flue gas.

9. A method for flue gas mercury emissions reduction comprising:
arranging a perforated housing arranged within a duct for a flow of a mercury-containing flue gas through the duct;
supplying an ammonium halide from an ammonium halide supply to a heated interior area of the perforated housing heated to a temperature of ammonium halide decomposition;
measuring with one or more sensors operating parameters within the duct and/or perforated housing to obtain parameter measurements electronically transmitted to a control device;
adjusting through electronic signal from the control device a rate of supply of the ammonium halide from the ammonium halide supply to the heated interior area of the perforated housing based on control device received parameter measurements; and
releasing NH₃ and HBr or HCl through decomposition of the ammonium halide for oxidation of elemental mercury present in the mercury-containing flue gas to obtain oxidized mercury for separation from the mercury-containing flue gas.

10. The method of claim 9, further comprising supplying a spray of ammonia within the duct and into the flow of mercury-containing flue gas through the duct.

11. The method of claim 9, wherein the heated interior area of the perforated housing is heated to a temperature of about 300° C. to about 490° C.

12. The method of claim 9, wherein the ammonium halide is a solid ammonium halide or an ammonium halide solution.

13. The method of claim 9, wherein the ammonium halide is an about 20 percent to about 70 percent ammonium halide solution and the duct comprises a vertical portion in which the perforated housing is arranged.

14. The method of claim 9, wherein the perforated housing is manufactured from a cut and expanded metal sheet.

15. The method of claim 9, further comprising separating the oxidized mercury from the flue gas using a particulate collection system and/or a wet flue gas desulfurization system.
